(19) United States
(12) Patent Application Publication
(10) Pub. No.: US 2026/0261033 A1
(43) Pub. Date: Sep. 3, 2026

(54) Unmanned aerial vehicle

(71) Applicant: ACSL Ltd., Tokyo (JP)

(72) Inventor: Hisayoshi Kuroda, Tokyo (JP)

(21) Appl. No.: 18/879,566

(22) PCT Filed: Jun. 30, 2022
(86) PCT No.: PCT/JP2022/026352

§ 371 Date: Apr. 22, 2025

(51) Int. Cl. H01Q 1/12; B64U 10/16; B64U 20/80; H01Q 1/28

(52) U.S. Cl. CPC H01Q 1/125; B64U 10/16; B64U 20/80; H01Q 1/282

(57) ABSTRACT

An unmanned aerial vehicle comprises: an antenna for communicating with a piloting apparatus that pilots the aerial vehicle; an acquisition unit that acquires a position of the aerial vehicle where the acquisition unit acquires a flight starting position of the aerial vehicle; a storage unit that stores the flight starting position; a direction determination unit that uses calculation to determine, on the basis of the present position and the flight starting position of the aerial vehicle where the positions were acquired by the acquisition unit, a direction of the flight starting position from the present position of the aerial vehicle; and an antenna control device that controls an orientation of the antenna, the antenna control device changing the orientation of the antenna from the present position of the aerial vehicle to the direction of the flight starting position where the direction was determined by the direction determination unit.

### TECHNICAL FIELD

The present invention relates to an unmanned aerial vehicle, and more specifically relates to an unmanned aerial whose an antenna is faced towards a piloting apparatus.

### BACKGROUND ART

Conventionally, in an antenna for communication which is mounted on an unmanned aerial vehicle such as a drone, multicopter etc., an omnidirectional antenna such as a monopole, dipole etc. is used.

### CITATION LIST

### Non Patent Literature

Patent Literature 1: JP 2019-121967 A

### SUMMARY OF INVENTION

### Technical Problem

An omnidirectional antenna has null points at the end directions of the antenna and the directions reverse thereto. Therefore, when at least one side of an unmanned aerial vehicle and piloting apparatus is positioned towards the null point directions of the antenna of the other side, there were cases of communication between the unmanned aerial vehicle and piloting apparatus becoming unstable, and occurrences of communication being cut off.

The present invention was conceived in order to solve the aforementioned problem, where one of the objectives is to provide an unmanned aerial vehicle that can ensure the stability of communication with a piloting apparatus.

### Solution to Problem

In one aspect of the present invention, an unmanned aerial vehicle includes: an antenna for communicating with a piloting apparatus that pilots the unmanned aerial vehicle; an acquisition unit that acquires a position of the unmanned aerial vehicle, the acquisition unit acquiring a flight starting position of the unmanned aerial vehicle and/or a position of the piloting apparatus; a storage unit that stores the flight starting position; a direction determination unit that uses calculation to determine, on the basis of a present position and the flight starting position of the unmanned aerial vehicle or a position of the piloting apparatus where these positions were acquired by the acquisition unit, a direction of the flight starting position or a position of the piloting apparatus from the present position; and an antenna control device that controls an orientation of the antenna, the antenna control device changing an orientation of the antenna to the direction which was determined by the direction determination unit.

### Advantageous Effects of Invention

According to the present invention, an unmanned aerial vehicle that can ensure the stability of communication with a piloting apparatus can be provided.

### BRIEF DESCRIPTION OF DRAWINGS

FIG. 1 is an external view of a multicopter which is one example of an unmanned aerial vehicle (multicopter) according to an embodiment.

FIG. 2 shows an entire configuration of an unmanned aerial vehicle according to an embodiment.

FIG. 3 is block diagram in relation to an antenna control of an unmanned aerial vehicle according to an embodiment.

FIG. 4 is one example of an operation flowchart in relation to an antenna control of an unmanned aerial vehicle according to an embodiment.

FIG. 5 is an external view of a multicopter which is one example of an unmanned aerial vehicle (multicopter) according to a modified example of the embodiment.

FIG. 6 is a block diagram of an adaptive array antenna.

### DESCRIPTION OF EMBODIMENTS

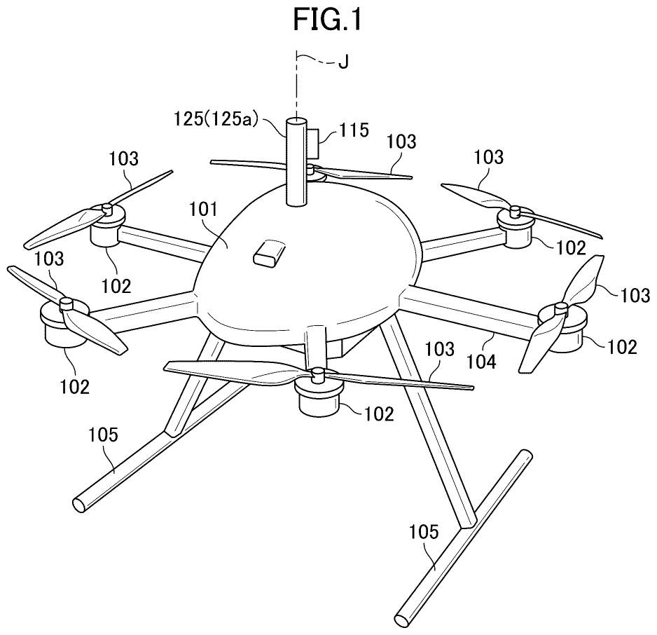

An embodiment of the present invention will be explained with reference to the drawings below. However, the present invention is not limited to the specific aspects explained below, but can take various aspects within the scope of the technological idea of the present invention. For example, the unmanned aerial vehicle of the present invention is not limited to the multicopter shown in FIG. 1, but may also be any unmanned aerial vehicle such as a rotorcraft, fixed-wing aircraft, etc. Moreover, the configuration of an unmanned aerial vehicle 1 is also not limited to those shown in the figures but can take any configuration if similar operations are enabled. For example, an operation which is executed by a plurality of constituent elements may be executed by a single constituent element, e.g. such as integrating the functions of a communication circuit into a flight control unit. Alternatively, an operation which is executed by a single constituent element may also be executed by a plurality of constituent elements, e.g. such as distributing the function of a control device to a plurality of control devices. Moreover, various kinds of data stored in the memory of an unmanned aerial vehicle 1 may be stored at a place different thereto. Moreover, for information recorded in various kinds of memory, one kind of information may be distributed and stored in a plurality of kinds of information, or a plurality of kinds of information may also be stored together in one kind of information.

### 1-1. Entire Configuration

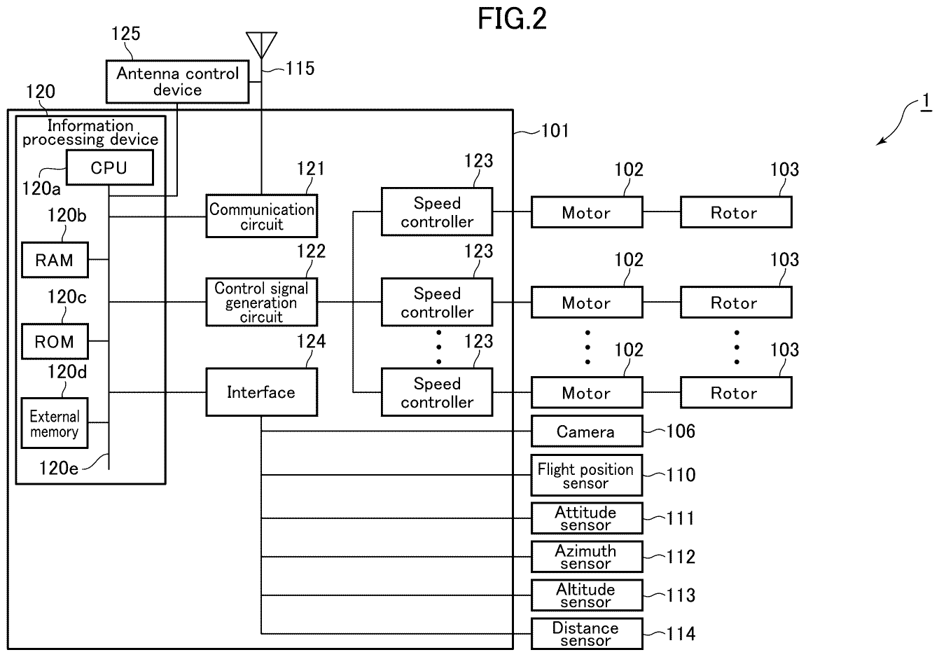

FIG. 1 is an external view of a multicopter which is one example of an unmanned aerial vehicle (multicopter) 1 according to the present embodiment. FIG. 2 shows an entire configuration of the unmanned aerial vehicle 1.

As shown in FIG. 1 and FIG. 2, the unmanned aerial vehicle 1 is provided with a control device 101, a motor 102, a rotor 103, an arm 104, a landing foot 105, a camera 106, a flight position sensor 110, an attitude sensor 111, an azimuth sensor 112, an altitude sensor 113, a distance sensor 114, and an antenna 115.

The control device 101 is a configuration of information processing for performing flight control of the unmanned aerial vehicle 1, and for performing control of the electric signals therefor, and is typically a device of which the circuits required in the achievement of such functions were configured by arranging and wiring various kinds of electronic components on a substrate. Details of the control device 101 are mentioned below.

The motor 102 is driven by a control signal from the control device 101. The rotors (rotating blades) 103 rotate by the drive of each of the motors 102 to generate lift. The arm 104 connects the control device 101 with each of the motors 102. The landing foot 105 supports the unmanned aerial vehicle 1 during landing. The number of motors 102, rotors 103 and arms 104 are six, as in the example shown in FIG. 1; however, the respective numbers can also be configured to be three or more, e.g. three or four. The flight of the unmanned aerial vehicle 1, such as raising, lowering, flight to the front-back and left-right, and turning etc., is controlled by controlling the number of revolutions of each of the six rotors 103 via the rotation of the six motors 102 by a control signal from the control device 101.

The camera 106 is a camera for photographing a target object at high resolution. The camera 106 is rotatably provided at the control device 101, and thereby the photographing direction can be changed. During the flight of the unmanned aerial vehicle 1, the camera 106 acquires image data of the photographic range thereof, and the acquired images are stored in the below-mentioned storage unit. The images are typically moving images consisting of a series of still images.

The flight position sensor 110 is a sensor which senses the position of the unmanned aerial vehicle 1, and is typically a GPS (Global Positioning System) sensor. The flight position sensor 110 suitably senses three-dimensional coordinates (latitude, longitude, altitude). In the present embodiment, the flight position sensor 110 senses the horizontal position (latitude, longitude) of the unmanned aerial vehicle 1.

The attitude sensor 111 is a sensor for detecting the movement and inclination etc. of the unmanned aerial vehicle 1, and is e.g. a six-axis gyro sensor (acceleration/angular velocity sensor). The attitude sensor 111 can be utilized for controlling the attitude of the unmanned aerial vehicle 1 during flight.

The azimuth sensor 112 is a sensor for controlling the flight direction, and is e.g. a magnetic sensor.

The altitude sensor 113 is a sensor for detecting the altitude of the unmanned aerial vehicle 1, and is e.g. an atmospheric sensor (barometer). The altitude sensor 113 can be utilized for controlling the flight altitude of the unmanned aerial vehicle 1.

The distance sensor 114 is a sensor for measuring a distance to an obstacle and ground surface, avoiding a collision with the obstacle, and precisely measuring the ground altitude. The distance sensor 114 is e.g. an ultrasonic sensor.

The antenna 115 is an antenna for receiving a wireless signal containing information and various kinds of data for piloting and controlling the unmanned aerial vehicle 1, and for transmitting a wireless signal containing an image signal, video signal and telemetry signal from the unmanned aerial vehicle 1. The antenna 115 can be used for communicating with a piloting apparatus that pilots the unmanned aerial vehicle 1. In FIG. 1, the antenna 115 is provided at the top portion of the unmanned aerial vehicle 1; however, this may also be provided at the bottom portion of the unmanned aerial vehicle 1, and may also be provided at any location thereof.

Although not illustrated, the unmanned aerial vehicle 1 is provided with a power supply system containing a battery device such as a lithium polymer battery, lithium-ion battery etc. and a power distribution system to each element.

As shown in FIG. 2, the control device 101 is provided with an information processing device 120, a communication circuit 121, a control signal generation circuit 122, a speed controller 123, an interface 124, and an antenna control device 125.

The communication circuit 121 is an electronic circuit for: demodulating a piloting signal, control signal and various kinds of data etc. for the unmanned aerial vehicle 1 from a wireless signal received through the antenna 115 and inputting these in the information processing device 120; and generating a wireless signal carrying an image signal, video signal, telemetry signal etc. output from the unmanned aerial vehicle 1. The communication circuit 121 is typically a wireless signal processing IC. For example, the communications of a piloting signal from piloting apparatus for piloting the unmanned aerial vehicle 1, and the communications of a control signal and various kinds of data may be configured so as to be executed with differing communication circuits of another frequency band. For example, a configuration can also be taken so as to communicate with a transmitter of a controller (proportional system or piloting apparatus) for manually performing piloting at a frequency of 920 MHz band, 2.4 GHz band, or 5.7 GHz band, and so as to communicate data communications at a frequency of 2 GHz band, 1.7 GHz band, 1.5 GHz band or 800 MHz band.

The information processing device 120 contains a CPU 120a, RAM 120b, ROM 120c, external memory 120d and system bus 120e. The RAM 120b, ROM 120c, external memory 120d, communication circuit 121, control signal generation circuit 122 and interface 124 are connected to the CPU 120a via the system bus 120e.

The information processing device 120 appropriately controls the flight of the unmanned aerial vehicle 1 based on a piloting signal (during non-autonomous flight) and flight plan route data (during autonomous flight) etc. from the operator. Specifically, the information processing device 120: determines the attitude, velocity etc. of the unmanned aerial vehicle 1 by the information obtainable from various kinds of sensors 111, 112 for flight control; determines the present flight position etc. of the unmanned aerial vehicle 1 by the information obtainable from the flight position sensor 110, the altitude sensor 113 and the distance sensor 114; calculates control command values for each of the rotors 103 with the information processing device 120 by comparing said values with target values of a piloting signal, flight plan route, velocity limit, altitude limit etc.; and outputs data showing the control command value to the control signal generation circuit 122.

The control signal generation circuit 122 is a configuration where the control command value data obtained by calculation by means of the information processing device 120 is converted to a pulse signal (PWM signal etc.) which expresses voltage, and is typically an IC containing an oscillating circuit and switching circuit. The control signal generation circuit 122 converts the control command values to pulse signals which express voltage and transmits these to each of the speed controllers 123.

The speed controller 123 is a configuration in which a pulse signal from the control signal generation circuit 122 is converted to a drive voltage which drives the motor 102, and is typically a smoothing circuit and analogue amplifier. Each of the speed controllers 123 convert the pulse signals thereof to drive voltages and applies them to each of the motors 102, thereby controlling the drive of each of the motors 102 to control the number of revolutions of each of the rotors 103, and thereby controlling the flight of the unmanned aerial vehicle 1.

The interface 124 is a configuration in which a signal form is converted so that signals can be sent/received between the interface 124 and functional elements such as the information processing device 120, flight position sensor 110, attitude sensor 111, azimuth sensor 112, altitude sensor 113 and distance sensor 114, to thereby electrically connect these. For convenience of explanation, the interface in the drawing is described as one configuration; however, other interfaces are normally used depending on the kind of functional elements of the connecting object. Moreover, there are also cases where the interface 124 is not necessary, depending on the kind of signal that the functional element of a connecting object inputs/outputs. Moreover, there is the information processing device 120 which is connected without mediation by the interface 124 as in FIG. 2, and there are also cases where an interface becomes necessary depending on the kind of signals that the functional element of the connecting object inputs/outputs.

The antenna control device 125 changes the orientation of the antenna 115. In the present embodiment, the antenna control device 125 is a rotating base 125a which is provided with the antenna 115, and the rotating base 125a is provided at the control device 101 as shown in FIG. 1. In the example shown in FIG. 1, the rotating base 125a is provided at the top portion of the unmanned aerial vehicle 1 (the control device 101); however, there is no particular limitation on the installation location as long as it is provided at the unmanned aerial vehicle 1. For example, the rotating base 125a may also be provided at the bottom portion of the unmanned aerial vehicle 1. In that case, the antenna 115 is positioned at the bottom portion of the unmanned aerial vehicle 1.

The rotating base 125a is rotatably configured about an axis J in the up/down direction. Although the rotating base 125a is not particularly illustrated, it has for example: a motor; a motor axis provided at the motor, this axis rotating about the axis J in the up/down direction by the drive of this motor; and a base fixed to the motor axis where the antenna 115 is mounted. A drive voltage based on the control command value of the rotation amount of this motor calculated by the control device 101 (e.g. the information processing device 120 or below-mentioned direction determination unit 150), is applied to this motor to rotate the rotating base 125a, thus changing the orientation of the antenna 115.

### 1-2. Detailed Configuration

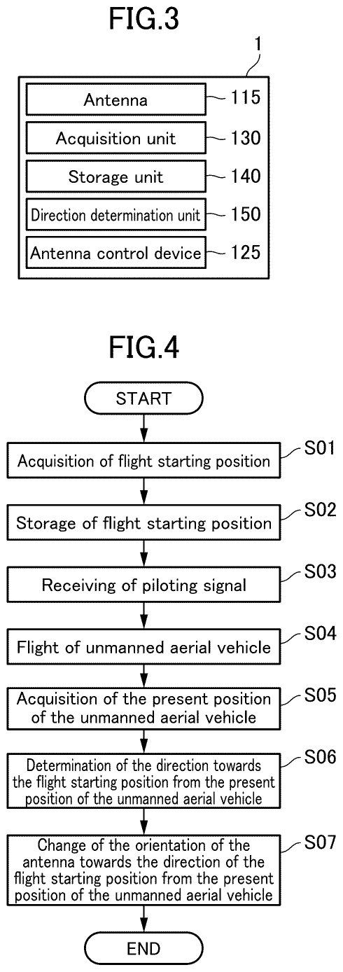

FIG. 3 is a block diagram relating to an antenna control of the unmanned aerial vehicle 1.

The unmanned aerial vehicle 1 is provided with the antenna 115, an acquisition unit 130, a storage unit 140, a direction determination unit 150, and the antenna control device 125.

The antenna 115 can be used for communicating with a piloting apparatus that pilots the unmanned aerial vehicle 1; for example, an omnidirectional antenna, directional antenna, and directional dual-polarization patch antenna (microstrip antenna) can be used. The directional dual-polarization patch antenna is e.g. a 180-degree directional dual-polarization patch antenna. In FIG. 1, the antenna 115 is provided at the top portion of the unmanned aerial vehicle 1; however, it may be provided at the bottom portion of the unmanned aerial vehicle 1, and may also be provided at any location of the unmanned aerial vehicle 1.

The acquisition unit 130 acquires the position of the unmanned aerial vehicle 1. The acquisition unit 130 is e.g. the flight position sensor 110 and the altitude sensor 113. The position of the unmanned aerial vehicle 1 can include the flight starting position of the unmanned aerial vehicle 1 at the time of flight start, as well as any position of the unmanned aerial vehicle 1 during the flight. Here, the flight starting position is a position of the unmanned aerial vehicle 1 at the time of flight start or immediately before this time. The position of the unmanned aerial vehicle 1 includes: the horizontal position (latitude, longitude) of the unmanned aerial vehicle 1 acquired by the flight position sensor 110; and the altitude of the unmanned aerial vehicle 1 acquired by the altitude sensor 113. The altitude is the height of which the sea level or mean sea level was configured as a criterion, and the height is the length in the vertical direction.

The acquisition unit 130 may also be configured so as to acquire the position of the piloting apparatus that pilots the unmanned aerial vehicle 1. Moreover, the position information of the unmanned aerial vehicle 1 and/or piloting apparatus acquired by the acquisition unit 130 may also be information acquired from an external unit. For example, the acquisition unit 130 may also acquire the flight starting position of the unmanned aerial vehicle 1 and/or the position of the piloting apparatus from an external unit via an input device such as a keyboard, mouse and touch panel.

The storage unit 140 stores the flight starting position acquired by the acquisition unit 130. The storage unit 140 can be configured of e.g. a memory or storage such as the RAM 120b, ROM 120c, external memory 120d included in the information processing device 120.

The direction determination unit 150 uses calculation to determine, on the basis of the present position and flight starting position of the unmanned aerial vehicle 1 where the positions were acquired by the acquisition unit 130, a direction of the flight starting position from the present position of the unmanned aerial vehicle 1. During this calculation, the direction determination unit 150 can take into consideration the attitude of the unmanned aerial vehicle 1 at the point in time of acquisition of the present position by the acquisition unit 130. The direction determination unit 150 can acquire the attitude of the unmanned aerial vehicle 1 by the attitude sensor 111. The direction determination unit 150 can be configured e.g. by the information processing device 120.

The calculation by the direction determination unit 150 of the direction of the flight starting position from the present position of the unmanned aerial vehicle 1 may be performed constantly, and may also be performed at a prescribed time interval. The setting of this time interval can be suitably set or changed. This time interval is a time interval of an extent to which the antenna 115 can track the position of the piloting apparatus (flight starting position of the unmanned aerial vehicle 1), e.g. this can be configured to be several seconds; however, there is no limitation to this.

The direction determination unit 150 of the present embodiment calculates the rotation amount command value towards the motor of the rotating base 125a, and outputs this to the antenna control device 125, in order for the antenna 115 to be oriented towards the direction of the flight starting position from the determined present position of the unmanned aerial vehicle 1. As another example, the information processing device 120 may be configured so as to perform the calculation of this rotation amount command value and to output it to the antenna control device 125.

The antenna control device 125 changes the orientation of the antenna 115 towards the direction of the flight starting position from the present position, the direction being determined by the direction determination unit 150. Namely, the antenna control device 125 (the rotating base 125a) rotates the antenna 115 so that the orientation of the antenna 115 faces towards the flight starting position. In the present embodiment, the antenna control device 125 has a control circuit, where this control circuit can be configured to include an IC containing an oscillation circuit and switching circuit, a smoothing circuit, and an analogue amplifier, similarly to the control signal generation circuit 122 and speed controller 123. Based on the rotation amount command value obtained from the direction determination unit 150 towards the motor of the rotating base 125a, the antenna control device 125 applies a drive voltage to the motor of the rotating base 125a to rotate this motor, and changes the orientation of the antenna 115 so as to face the flight starting position. The phrase “the orientation of the antenna 115 faces the flight starting position” means that the direction where the sensitivity of the antenna 115 is high is faced towards the flight starting position or piloting apparatus, where it is preferable that the direction where the sensitivity of the antenna 115 is the highest is faced towards the flight starting position or piloting apparatus.

### 1-3. Operation

FIG. 4 is one example of an operation flowchart relating to an antenna control of the unmanned aerial vehicle 1. Here, during the start of flight, the unmanned aerial vehicle 1, and the piloting apparatus for performing piloting of the unmanned aerial vehicle 1 are positioned within a comparatively near range of distance (e.g. several tens of cm to several m), and communication between these is thus configured to be able to be stably performed.

Firstly, at the start of flight, the unmanned aerial vehicle 1 acquires the flight starting position by means of the flight position sensor 110 and altitude sensor 113 (S01: acquisition of flight starting position). The acquired flight starting position is stored in the storage unit 140 (S02: storage of flight starting position).

Next, the unmanned aerial vehicle 1 receives a piloting signal from piloting apparatus via the antenna 115 (S03: receiving of piloting signal), and based on this piloting signal, the motor 102 is made to drive and the rotor 103 is made to rotate, and flight thereby takes place (S04: flight of unmanned aerial vehicle).

During the flight of the unmanned aerial vehicle 1, the unmanned aerial vehicle 1 acquires the present position of the unmanned aerial vehicle 1 by means of the flight position sensor 110 and altitude sensor 113 (S05: acquisition of the present position of the unmanned aerial vehicle). On the basis of the acquired present position and flight starting position stored in the storage unit 140, the direction determination unit 150 calculates the direction of the flight starting position from the present position, and determines this direction (S06: determination of the direction towards the flight starting position from the present position of the unmanned aerial vehicle). Furthermore, in the present embodiment, the direction determination unit 150 calculates the rotation amount for the motor of the rotating base 125a as a command value, and outputs this command value to the antenna control device 125 (the rotating base 125a), so that the antenna 115 is configured so as to be oriented towards the direction of the flight starting position from the present position of the unmanned aerial vehicle 1.

The antenna control device 125 changes the orientation of the antenna 115 toward the direction of the flight starting position from the present position of the unmanned aerial vehicle 1, the direction being determined by the direction determination unit 150 (S07: change of the orientation of the antenna towards the direction of the flight starting position from the present position of the unmanned aerial vehicle). Here, based on the rotation amount command value obtained from the direction determination unit 150 towards the motor of the rotating base 125a, the antenna control device 125 applies a drive voltage to the motor of the rotating base 125a to rotate this motor, and change the orientation of the antenna 115 so as to face the flight starting position.

### 1-4. Effect in the Present Embodiment

(1) The unmanned aerial vehicle 1 of the present embodiment is configured so as to include: the antenna 115 for communicating with a piloting apparatus that pilots the unmanned aerial vehicle 1; the acquisition unit 130 that acquires a position of the unmanned aerial vehicle 1 where the acquisition unit 130 acquires a flight starting position of the unmanned aerial vehicle 1; the storage unit 140 that stores the flight starting position; the direction determination unit 150 that uses calculation to determine, on the basis of the present position and the flight starting position of the unmanned aerial vehicle 1 where the positions were acquired by the acquisition unit 130, a direction of the flight starting position from the present position of the unmanned aerial vehicle 1; and the antenna control device 125 that controls the orientation of the antenna 115, the antenna control device 125 changing the orientation of the antenna 115 toward the direction of the flight starting position from the present position of the unmanned aerial vehicle 1, the direction being determined by the direction determination unit 150.

Thereby, the unmanned aerial vehicle 1 can ensure the stability of communication with a piloting apparatus. Since the orientation of the antenna 115 can be faced towards the flight starting position, cut off of communication and interruption of video transmission can be prevented when the antennas of the unmanned aerial vehicle 1 and piloting apparatus were oriented towards null point directions thereof. In the conventional technology of unmanned aerial vehicles, if the null point directions of the antenna which these unmanned aerial vehicles have, and the null point directions of the antenna of the piloting apparatus coincide, then taking into consideration the communication cut off which occurs at far distances, there needed to be a limitation on the communicable distance of both parties. In contrast, in the present embodiment, since the directionality of the antenna 115 can be oriented towards the flight starting position there is no need to impose the aforementioned limitation. Namely, because constraints on the communicable distance due to having the conventional null points can be eliminated, the communicable distance can be extended. Moreover, by performing communication with the piloting apparatus with a 2.4 GHz band, stabilized communications can be established even in mountainous regions. As mentioned above, the facing of the orientation of the antenna 115 towards the flight starting position is because the position of the piloting apparatus which pilots the unmanned aerial vehicle 1 and the flight starting position are comparatively near, and hence it can be deemed to be an equivalent position in terms of communicating.

(2) The antenna control device 125 is configured with the rotating base 125a which is provided with the antenna 115. Thereby, even if the position thereof was changed due to the flight of the unmanned aerial vehicle 1, the orientation of the antenna 115 can be faced towards the piloting apparatus.

(3) The antenna 115 is configured with a directional dual-polarization patch antenna. Thereby, compared to the case where an omnidirectional antenna or directional antenna is used as the antenna 115, the stability of communication can be ensured.

### 2. Other Embodiments

Modified examples of the aforementioned embodiment will be explained. In the below modified example in relation to the aforementioned embodiment, only the configuration which differs to the aforementioned embodiment will be explained, and explanation of the same configurations will be omitted. The below Modified Examples 1, 2 and 3, as well as any combination of Modified Examples 1 to 3 in relation to the aforementioned embodiment are included in the scope of the present invention.

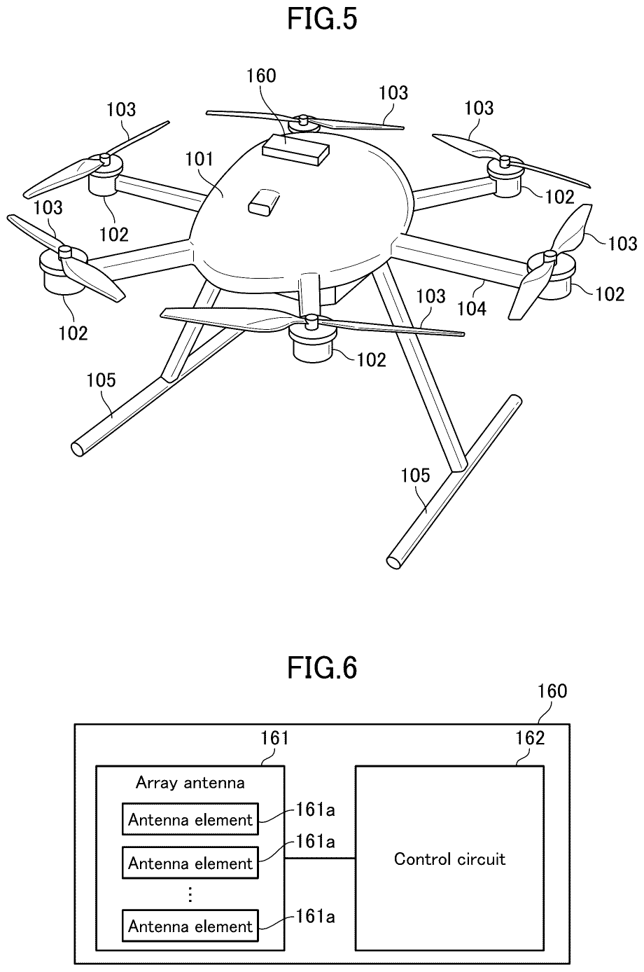

(1) As Modified Example 1 of the aforementioned embodiment, the unmanned aerial vehicle 1 may also be configured so as be provided with an adaptive array antenna 160, as shown in FIG. 5. As shown in FIG. 6, the adaptive array antenna 160 has an array antenna 161 in which a plurality of antenna elements 161a is arranged, and a control circuit 162 which controls the array antenna 161. The adaptive array antenna 160 is an antenna which adaptively controls the weighting of each of the antenna elements 161a by means of the control circuit 162 depending on the propagation environment, and electrically controls the directionality thereof. In the present Modified Example 1, the adaptive array antenna 160 is provided instead of the rotating base 125a. Namely, the array antenna 161 is the antenna 115, and the control circuit 162 is the antenna control device 125. In other words, in the aforementioned embodiment, the antenna control device 125 changes the directionality of the antenna 115 by a rotating drive, whereas in the present Modified Example 1, the directionality of the antenna array 161 is electrically changed by the control circuit 162. Although the adaptive array antenna 160 is provided at the top portion of the unmanned aerial vehicle 1 in FIG. 5, the adaptive array antenna 160 or array antenna 161 may be provided at the bottom portion of the unmanned aerial vehicle 1, and may also be provided at any location of the unmanned aerial vehicle 1.

In the present Modified Example 1, the control circuit 162 determines the weighting coefficients for each antenna element, and based on these weighting coefficients, controls each antenna element for amplitude and/or phase, so that the directionality of the array antenna 161 faces toward the direction of the flight starting position from the present position of the unmanned aerial vehicle 1 where the direction was determined by the direction determination unit 150. In another example, the information processing device 120 determines the weighting coefficients for each antenna element 161a, and outputs these weighting coefficients to the control circuit 162, so that the directionality of the array antenna 161 faces toward the direction of the flight starting position from the present position of the unmanned aerial vehicle 1, the direction being determined by the direction determination unit 150. The control circuit 162 controls each of the antenna elements 161a for the amplitude and/or phase, based on these weighting coefficients.

Thus, since the antenna of the unmanned aerial vehicle 1 can be oriented towards the piloting apparatus, the stability of communication can be ensured.

(2) As Modified Example 2 of the aforementioned embodiment, the acquisition unit 130 may be configured so as to acquire the position of the piloting apparatus received from the piloting apparatus at the time of flight start, as the flight starting position. Namely, in the aforementioned embodiment, the flight starting position is the position of the unmanned aerial vehicle 1 acquired by the flight position sensor 110 and altitude sensor 113, whereas in the present Modified Example 2, it is the position of the piloting apparatus. In one example, the position of the piloting apparatus can be acquired by a position transmitter provided at the piloting apparatus, and in another example, it can be acquired from an external unit other than the piloting apparatus and unmanned aerial vehicle 1, via an input device such as a keyboard, mouse and touch panel. In that case, the direction determination unit 150 uses calculation to determine, on the basis of the position of the piloting apparatus and the present position of the unmanned aerial vehicle 1, the direction of the position of the piloting apparatus from this present position.

Thus, the unmanned aerial vehicle 1 can ensure the stability of communication with a piloting apparatus. Namely, since the time of flight start is usually when the unmanned aerial vehicle 1 and piloting apparatus are comparatively near (e.g., range of several meters), the unmanned aerial vehicle 1 and piloting apparatus are communicable. Accordingly, since the unmanned aerial vehicle 1 can obtain the position of the piloting apparatus which becomes the base point for facing the antenna 115, the stability of communication can be ensured.

(3) As Modified Example 3 of the aforementioned embodiment, the acquisition unit 130 acquires the flight starting position, and after the unmanned aerial vehicle 1 has started flight, further acquires the position of the piloting apparatus from the piloting apparatus. The storage unit 140 stores the position of the piloting apparatus. The direction determination unit 150 may also be configured so as to use calculation to determine, on the basis of the position of the piloting apparatus and the present position of the unmanned aerial vehicle 1, the direction of the position of the piloting apparatus from this present position.

Thereby, even if the position of the piloting apparatus has changed after the flight of the unmanned aerial vehicle 1, the antenna 115 can be oriented towards the piloting apparatus.

Moreover, in the aforementioned Modified Example 3, the flight starting position and the position of the piloting apparatus were configured so as to be stored in the storage unit 140; however, after the unmanned aerial vehicle 1 has started flight, if the position of the piloting apparatus was acquired, the flight starting position stored in the storage unit 140 may also be stored so as to over-write the position of the piloting apparatus. In that case, the direction determination unit 150 can use calculation to determine the direction of the flight starting position (namely, position of the piloting apparatus) from the present position of the unmanned aerial vehicle 1.

### REFERENCE SIGNS LIST

1 Unmanned aerial vehicle
101 Control device
102 Motor
103 Rotor
104 Arm
105 Landing foot
106 Camera
110 Flight position sensor
111 Attitude sensor
112 Azimuth sensor
113 Altitude sensor
114 Distance sensor
115 Antenna
120 Information processing device
121 Communication circuit
122 Control signal generation circuit
123 Speed controller
124 Interface
125 Antenna control device
125a Rotating base
130 Acquisition unit
140 Storage unit
160 Adaptive array antenna
161 Antenna array
161a Antenna element
162 Control circuit

1. An unmanned aerial vehicle, comprising:
an antenna for communicating with a piloting apparatus that pilots the unmanned aerial vehicle;
an acquisition unit that acquires a position of the unmanned aerial vehicle, the acquisition unit acquiring a flight starting position of the unmanned aerial vehicle and/or a position of the piloting apparatus;
a storage unit that stores the flight starting position;
a direction determination unit that uses calculation to determine, on the basis of a present position and the flight starting position of the unmanned aerial vehicle or a position of the piloting apparatus where the positions were acquired by the acquisition unit, a direction of the flight starting position or a position of the piloting apparatus from the present position; and
an antenna control device that controls an orientation of the antenna, the antenna control device changing an orientation of the antenna to the direction which was determined by the direction determination unit.

2. The unmanned aerial vehicle according to claim 1, wherein the antenna control device is a rotating base which is provided with the antenna.

3. The unmanned aerial vehicle according to claim 1, comprising
an adaptive array antenna having an array antenna in which a plurality of antenna elements is arranged and a control circuit which controls the array antenna, wherein
the array antenna is the antenna, and
the control circuit is the antenna control device.

4. The unmanned aerial vehicle according to claim 1, wherein the antenna is a directional dual-polarization patch antenna.

5. The unmanned aerial vehicle according to claims 1, wherein the acquisition unit acquires a position of the piloting apparatus at the time of flight start, the position being received from the piloting apparatus, as the flight starting position.

6. The unmanned aerial vehicle according to claim 1, wherein
the acquisition unit acquires the flight starting position, and after the unmanned aerial vehicle has started flight, further acquires a position of the piloting apparatus from the piloting apparatus,
the storage unit further stores a position of the piloting apparatus,
the direction determination unit uses calculation to determine, on the basis of a position of the piloting apparatus and a present position of the unmanned aerial vehicle, a direction of a position of the piloting apparatus from this present position.
